(19) United States
(12) Patent Application Publication
(10) Pub. No.: US 2026/0181034 A1
(43) Pub. Date: Jun. 25, 2026

(54) COLLABORATIVE MEDIA TRANSCRIPTION SYSTEM WITH FAILED CONNECTION MITIGATION

(71) Applicant: TRINT LIMITED, London (GB)

(72) Inventors: James MORRISON, London (GB); Ferrán GARRIGA, London (GB); Ionut-Bogdan LARGEANU, London (CA); Christopher GUEST, London (GB); Jinn KORIECH, London (GB); Odhrán MCCONNELL, London (GB); Jeffrey KOFMAN, London (GB); Ryan FELINE, London (GB); Peter SLIGHT, London (GB)

(21) Appl. No.: 19/109,979

(22) PCT Filed: Sep. 11, 2023
(86) PCT No.: PCT/GB2023/052345

§ 371 Date: Mar. 7, 2025

Related U.S. Application Data
(60) Provisional application No. 63/405,204, filed on Sep. 9, 2022.

(51) Int. Cl. H04L 65/75; H04L 65/611; H04L 67/06; H04N 21/845

(52) U.S. Cl. CPC H04L 65/765; H04L 65/611; H04L 67/06; H04N 21/8456

(57) ABSTRACT

A collaborative media collection and transcription system with failed connection mitigation is disclosed. A stream of audio data is divided into a time-ordered sequence of corresponding digital data segments as the stream of audio data is captured; the sequence of digital data segments is provided over a communication network to a remote server for real-time transcription by: identifying a digital data segment from the sequence as a current data segment for transmitting; verifying whether a valid network connection exists between the first electronic device and the communication network, and repeating the verifying when the verifying fails to indicate that the valid network connection exists; (c) when the verifying indicates that the valid network connection exists: (i) transmitting the current data segment over the communication network for the remote server; and (ii) monitoring for confirmation that the current data segment has been successfully transmitted to the remote server.

### RELATED APPLICATIONS

This application claims the benefit of and priority to U.S. Provisional Patent Application No. 63/405,204, filed Sep. 9, 2022, the contents of which are incorporated herein by reference.

### FIELD

This disclosure relates generally to media transcription and distribution systems, and more particularly to a collaborative media transcription system with failed connection mitigation.

### BACKGROUND

Quick dissemination of accurate and trustworthy information over media distributions systems that rely on networks such as the Internet has become critical. Cloud-based solutions can enable multiple people to collaborate to provide such information. For example, a first person can capture a live audio or video of an event in real-time using a device such a smartphone. The audio or video can be uploaded as a media stream to a cloud-based service that enables review and editing by multiple authorized users for inclusion in media content that can be streamed to or downloaded by end users. Automated Speech-to-Text transcription can be provided to add accompanying text content to the audio or video media content.

Internet connected devices, and mobile devices in particular, are prone to connection failure for a variety of reasons. For example, if a user is attempting to upload media to an internet service using their mobile device in transit through a network dead-zone, the connection can potentially be lost and the upload will fail either in part or completely. A collaborative media distribution process can fail or lose accuracy when connectivity between an originating user device and an Internet based processing and distribution system fails.

Accordingly, there is a need for a collaborative media transcription system that can mitigate against delays and inaccuracies in the dissemination of media when network connectivity fails.

### SUMMARY

According to an example aspect, a computer implemented method and system is described that includes a collaborative media collection and transcription system with failed connection mitigation.

According to a first example aspect, a method is disclosed for capturing a live audio stream for real-time transcription. The method includes, at a first electronic device: capturing a stream of audio data using a microphone; processing the stream of audio data into a time-ordered sequence of corresponding digital data segments as the stream of audio data is captured; and providing the sequence of digital data segments over a communication network to a remote server for real-time transcription. Providing the digital data segments over the communication network includes: (a) identifying a digital data segment from the sequence as a current data segment for transmitting; (b) verifying whether a valid network connection exists between the first electronic device and the communication network, and repeating the verifying when the verifying fails to indicate that the valid network connection exists; (c) when the verifying indicates that the valid network connection exists: (i) transmitting the current data segment over the communication network for the remote server; and (ii) monitoring for confirmation that the current data segment has been successfully transmitted to the remote server; (d) when the monitoring fails to confirm that the current data segment has been successfully transmitted, repeating (b) and (c); and (e) when the monitoring confirms that the current data segment has been successfully transmitted, identifying a next digital data segment from the sequence as the current data segment and repeating (b), (c) and (d).

The operations (b), (c), (d) and (e) are preformed repeatedly until all digital data segments in the sequence are provided to the remote server or a defined termination condition occurs. The defined termination condition can include the verifying failing, for a predefined duration, to indicate that the valid network connection exists.

In some examples, the method includes, at the remote server: receiving the sequence of digital data segments; appending the digital data segments to an audio playlist as they are received and storing the audio playlist; obtaining automated text transcriptions for the digital data segments as they are received, the text transcription for each digital data segment including a text representation of spoken words represented in the digital data segment together with time stamp data that aligns the text representations with locations of the spoken words in the audio playlist; and appending the text transcriptions to a transcript file in real-time as they are obtained.

In some examples, the remote server provides the audio playlist and the transcript file in real-time to a collaborative editor that enables multiple user devices to display the text transcriptions in time alignment with audio playback of the audio playlist.

In some example aspects, the present disclosure describes a computing system including a processing unit configured to execute computer-readable instructions to cause the system to perform the method of any one of the preceding example aspects of the method.

In another example aspect, the present disclosure describes a non-transitory computer readable medium having machine-executable instructions stored thereon, where the instructions, when executed by a processing unit of an apparatus, cause the apparatus to perform the method of any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating a collaborative media transcription system according to example implementations.

FIG. 2 is a block diagram of an example computing system that may be used to implement examples of the present disclosure.

FIG. 3 is a block diagram illustrating modules of the collaborative media transcription system of FIG. 1 according to example implementations.

FIG. 4 illustrates a transmission queue stored at a media capture and communication device of the collaborative media transcription system of FIG. 1.

FIG. 5 is a block diagram illustrating a sequence of network validation operations that can be performed by the media capture and communication device.

FIG. 6 is a flow diagram of operations performed by the media capture and communication device of the collaborative media transcription system of FIG. 1.

FIG. 7 is a flow diagram of operations performed by a transcription system of the collaborative media transcription system of FIG. 1, according to example embodiments.

Similar reference numerals may have been used in different figures to denote similar components.

### DESCRIPTION OF EXAMPLE EMBODIMENTS

According to an example embodiment, a collaborative media transcription system is disclosed that can mitigate against connectivity failures that may occur between a media capture and communication (MCC) device and an Internet based (e.g., Cloud based) media processing and distribution system that includes a collaborative transcription editing system.

By way of context, an illustrative example of a connectivity failure, referred to as a “train tunnel scenario”, can be described as follows:
1. A journalist wants to use a mobile device to capture a media content stream for an interview of a high ranking politician on a train and send the media content stream using a wireless network connection to an Internet based system to be transcribed in real time, with the transcription viewed and edited by the journalist's colleagues (for example at a news desk), along with the original media content.
2. Should the train enter a tunnel, the data signal used to transmit the media content stream could potentially be lost.
3. It is essential the interview be recorded accurately with no data lost during the transmission process.
4. It is also important for the interview to be sent to the news desk as a transcription as quickly as possible, and as close to real time as possible.

In some examples, connectivity failure can last a few seconds. In other examples, connectively failure may extend over much longer time periods for example hours or days. Example embodiments are described that can address issues that arise from short connectivity failures that last seconds in durations to longer connectivity failures that can extend over hours or even days.

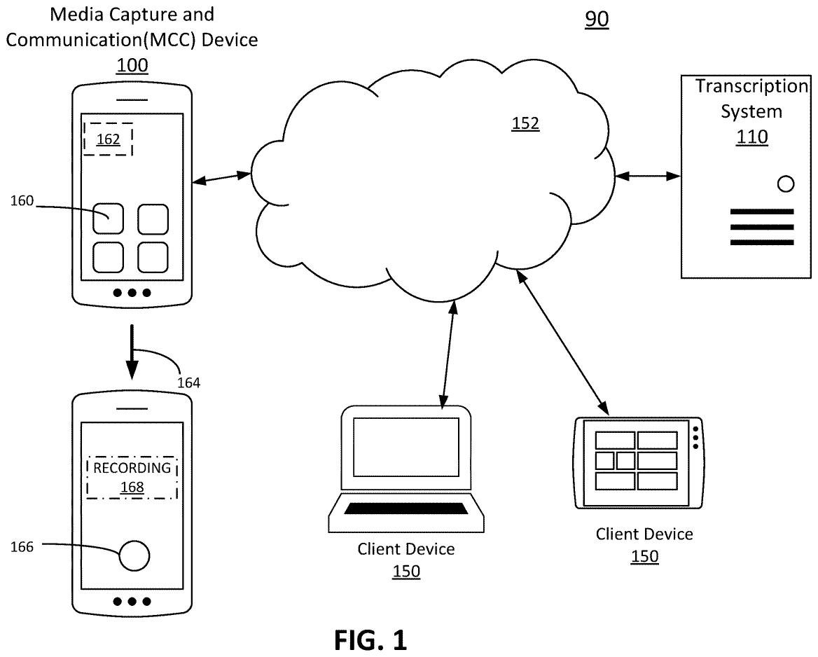

In this regard, FIG. 1 depicts an example embodiment of components that can be included in a collaborative media transcription system 90 (hereafter “system 90”) that can mitigate against loss of connectivity. System 90 includes a media capture and communication (MCC) device 100 and a cloud-based transcription system 110 that communicate with each other through a communication network 152. MCC device 100 may for example be a processor-based wireless network-enabled computing device such as a smartphone, a laptop computer, or a tablet, among other devices. In at least some examples, MCC device 100 is a common-off-the-shelf (COTS) device (for example, a conventional 5G, 6G and/or LTE enabled smart phone) that is configured with specialized software to perform the functionality described herein. Although described herein as a wireless network enabled device, it will be appreciated that wired networks can also have transient connectivity issues, and accordingly in some examples, MCC device 100 can alternatively be a device such as a stationary desktop computer that has a wired network connection.

In the illustrated example, MCC device 100 is configured to maintain connectivity with communication network 152, which can for example include the Internet as well as intervening wireless and/or wired networks. By way of example, communication network 152 can include any wireless network capable of enabling a plurality of communication devices to wirelessly exchange data such as, for example, a wireless Wide Area Network (WAN) such as a cellular network (e.g., an LTE, 4G, 5G, or 6G network), a wireless local area network (WLAN) such as Wi-Fi™, or a wireless personal area network (WPAN) (not shown), such as Bluetooth™ based WPAN. The MCC device 100 may be configured to communicate over all of the aforementioned network types and to roam between different networks. Communication network 152 can include a network gateway that connects intermediate networks to the Internet.

In some examples, communication network 152 may be a private network that does not include the Internet, for example an internal enterprise network operated by a business, university, government agency or other entity.

Transcription system 110, which as indicated above can be a cloud-based system that is accessible through the Internet, is configured to receive and process media content streams from one or more media capture and communication (MCC) devices 100. In example embodiments, transcription system 110 auto-generates a text transcript of spoken words that are included as an audio component of the media content stream. The text transcript includes timing metadata to enable the text transcript to be displayed in time synchronization with audio playback of the audio component. Transcription system 110 enables multiple users to access a playback and text editing tool through respective client devices 150 to collaboratively correct the auto-generated text transcript. Client devices 150 can, for example, include processor enabled computing devices such as laptop-computers, desktop computers, smart phones, tablets and the like that can interface with transcription system 110 via communication network 152 to enable user review of media content and collaborative text editing of an associated text transcript.

Non-limiting examples of transcription and editing systems than can be used to implement one or more features of transcription system 110 are disclosed in U.S. Pat. No. 10,546,588, “MEDIA GENERATING AND EDITING SYSTEM” and U.S. Pat. No. 11,301,644, “GENERATING AND EDITING MEDIA”, both issued to Trint Limited, the contents of which are incorporated herein by reference.

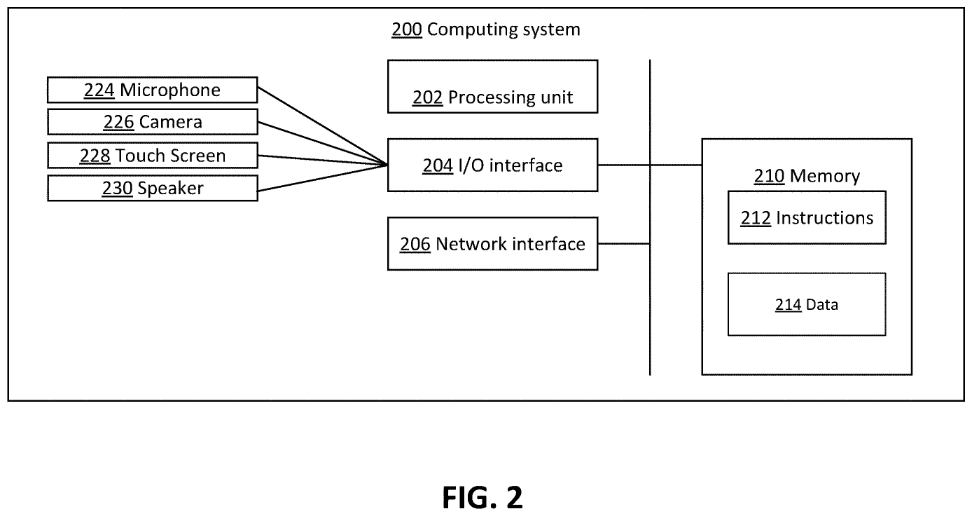

FIG. 2 is a block diagram illustrating a simplified example of processor enabled computer system 200 that may be used for implementing one or more of the elements of the system 90. For example, MCC device 100 may be implemented using a first computing system 200 that is configured as a mobile electronic device such as a COTS smart phone. Transcription system 110 may be implemented using a second computer system 200 that is configured as a web-based server. Although FIG. 2 shows a single instance of each element, there may be multiple instances of each element in the computing system 200.

In this example, the computing system 200 includes at least one processing unit 202, which may be a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, combinations thereof, or other such hardware structure.

The computing system 200 may include an input/output (I/O) interface 204, which may enable interfacing with an input device and/or output device. In the case where computing system 200 is used to implement MCC device 100, the I/O devices can include a microphone 224, camera 226, touch screen 228 and speaker 230, among other things.

The computing system 200 includes a network interface 206 for wired or wireless communication with other computing systems. The network interface 406 may include wired links (e.g., Ethernet cable) and/or wireless links (e.g., one or more antennas) for intra-network and/or inter-network communications. In example embodiments, the network interface 206 facilitates communications that occur through communication network 152.

The computing system 200 may include a memory 210, which may include volatile and non-volatile memory components (e.g., a flash memory, a random access memory (RAM), and/or a read-only memory (ROM)). The non-transitory or non-volatile components of memory 210 may store instructions 212 for execution by the processing unit 202, such as to carry out example embodiments described in the present disclosure. The memory 212 may also store data 214 that is created by and/or supports the operation of computing system 200. For example, in the case where computing system 200 is used to implement MCC device 100, memory 210 may store instructions 212 for implementing the MCC device 100 modules that are described below. In the case where computing system 200 is used to implement transcription system 110 MCC device 100, memory 210 may store instructions 212 for implementing transcription system 110 modules that are described below. The memory 210 may include other software instructions, such as for implementing an operating system and other applications/functions.

With reference to FIG. 1, in one example the instructions 212 for implementing the MCC device 100 modules that are described below can be organized into an MCC application 162 or software program that is stored in memory 210 of MCC device 100. In one example, an application manager of an operating system (OS) of the MCC device 100 is configured to display an icon 160 in a graphical user interface (GUI) displayed by a touchscreen 228 of the MCC device 100. User input (for example user selection via touch input of the icon 160) causes the MCC device 100 to initialize and run MCC application 162. As indicated by arrow 164, once running, MCC application 162 causes a further GUI to be displayed that can include a recording activation button 166. Further user input (for example user selection via touch input of the button 166) causes the MCC application 162 to commence a live media capture session. In some examples, an indicator can be generated in the GUI (for example “RECORDING” banner 168) indicating that a live media capture session is in progress. In example embodiments, commencement of a live media capture session causes the MCC device 100 to: (1) start recording audio using a microphone 224 of the MCC device 100 and (2) exchange messages (e.g., a security handshake) with transcription system 110 via communication network 152 to cause the transcription system 110 to start a corresponding live media processing session.

In example embodiments, each new live media processing session is assigned a unique ID that is stored at each of the MCC device 100 and the transcription system 110. In at least some examples, the MCC device 100 and the transcription system 110 each track and store status data in non-transient storage that indicates the current state of a live media processing session, for example “active” once the live media processing session has started, “complete” when the live media processing session has ended, or “interrupted” in that network connectivity has been lost and not yet restored.

A further user input (for example a user touch selection of button 166 for a defined touch duration) can be used to signal an end to the MCC live media capture session and corresponding transcription system 110 live media processing session. In example embodiments, both the MCC device 100 and the transcription system 110 will update the status data stored in respect of a live media processing session to indicate “complete” upon receiving the user input signaling the end to the live MCC media capture session.

In some examples, each time the MCC device 100 initializes and runs MCC application 162, as part of the initialization the MCC application 162 checks to see if the stored status data for the last live media processing session indicates that the last live media session failed before being completed (e.g., the session has a “live” or“interrupted” status). In such cases, the MCC application can cause the data segment transmission process between the MCC device 100 and the transcription system 110 to be restarted with the data segment that is currently stored in the current-data-segment-to-transmit location of the transmission queue 402. In some examples, prior to restarting the previously interrupted session, the MCC application 162 causes the user to presented with a user selectable option (for example a GUI button) to either restart the previously interrupted session or to discard the previously interrupted session. The persistently stored status data and transmission queue 402 enable sessions to be restarted even after a prolonged loss of connectivity between the MCC device 100 and the transcription system 110.

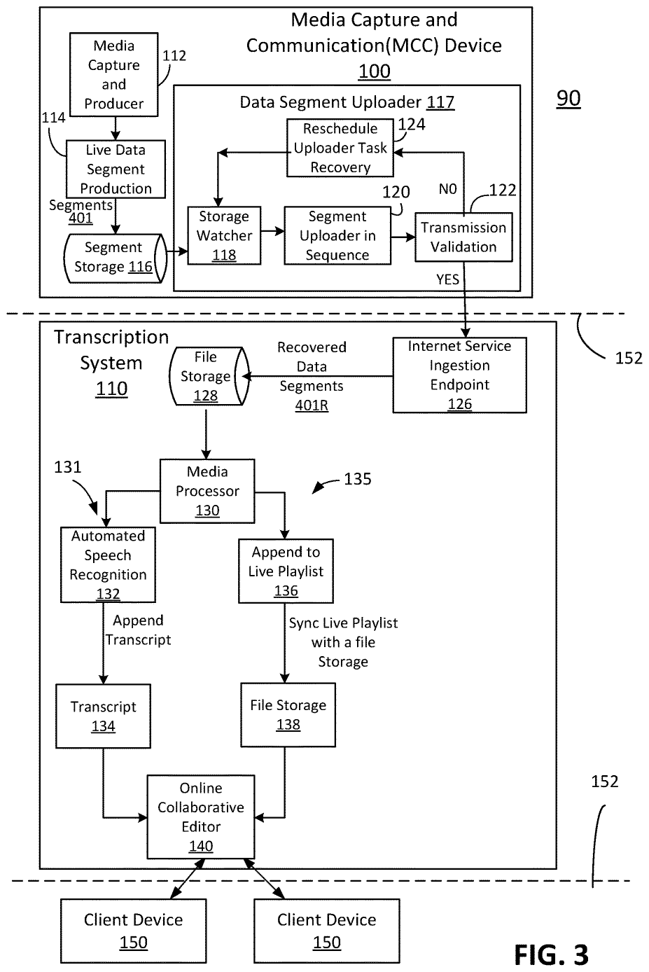

Modules of MCC device 100 and transcription system 110 that respectively support an MCC live media capture session and corresponding transcription system 100 live media processing session will now be described in greater detail with reference to FIG. 3. As used here, a “module” can refer to a combination of a hardware processing circuit and machine-readable instructions and data (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

In some examples, one or more modules can be implemented using suitably configured processor enabled computer devices or systems (e.g., computing system 200), such as personal computers, industrial computers, laptop computers, computer servers and programmable logic controllers. In some examples, individual modules may be implemented using a dedicated processor enabled computer device, in some examples multiple modules may be implemented using a common processor enabled computer device, and in some examples the functions of individual modules may be distributed among multiple processor enabled computer devices. In the illustrated example, MCC device 100 includes the following modules (as noted above these modules can form parts of MCC application 162).

Media stream capture and output producer module 112—a module that captures real-time audio data through a microphone 224 of the MCC device 100 and video through a video camera 226 of the MCC device 100 to generate media content in the form of a continuous uninterrupted media data stream of audio and video data. In some examples, the media stream capture and output producer module 112 may be substituted with, or be able to selectively operate as, an audio-only module that captures audio data via microphone 224 without also capturing video data, such that the generated media stream is an audio-only stream. In one example, media stream capture and output producer module 112 outputs a pulse code modulated (PCM) byte array stream of audio data.

Live data segment production module 114—module that takes the continuous uninterrupted media stream of media data generated by the Audio/Video output producer module 112 and splits the continuous data stream into a sequence of time data segments 401 (also referred to as chunks) of a predefined size or duration. In one example, each digital data segment 401 contains data corresponding to about one (1) second of recorded audio data. However, longer or shorter data segments can be used in different examples. For example, in various embodiments, the predefined length of data segments 401 can be selected from a range of 0.5 seconds to 3 seconds. In other embodiments, the predefined length of data segments 401 could be any defined amount that meets the requirements of the use case. The data segments 401 can be time stamped and/or uniquely identified and encoded for transmission or left unmodified. For example, in some example embodiments the data segments 401 can be encoded to a codec that is more suitable for processing by modules of the MCC device 100 or the transcription system 110 and/or more suitable for transmission through the communication network 152. In some examples, the live data segment production module 114 is configured to output audio data in a Waveform Audio (WAV) file format, which starts with a file header that is followed with a sequence of the data segments 401. In some examples, each data segment 401 is formatted as a discrete WAV file that has a WAV file header and one PCM data segment.

Segment storage module 116—module that stores the data segments 401 generated by the Live data segment production module 114 in persistent storage (e.g., as data 214 in memory 210) of the MCC device 100.

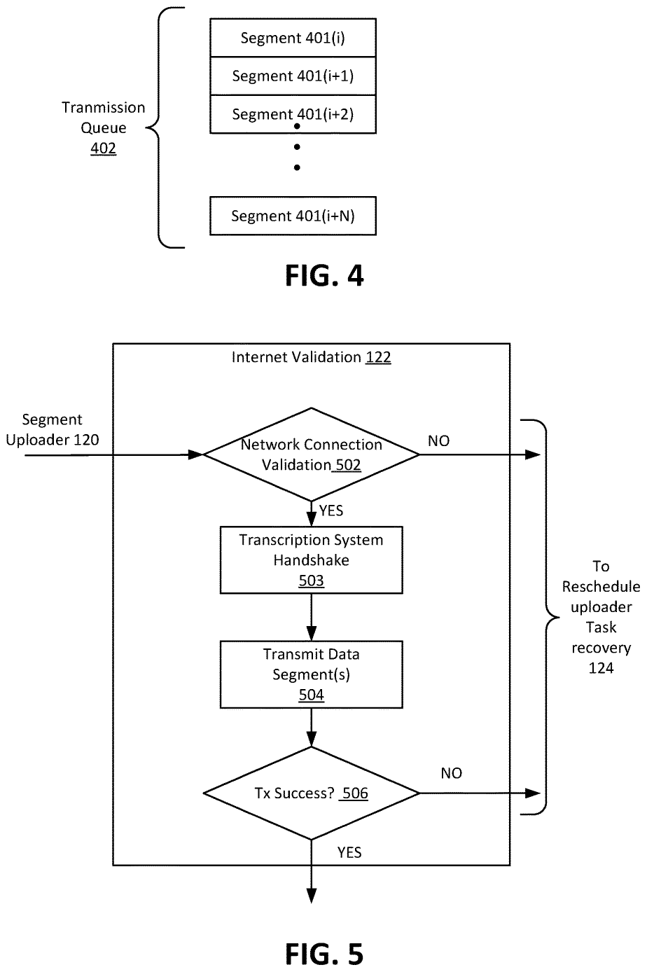

Data Segment Uploader module 117—module that manages transmission of the data segments 401 through the communication network 152. By way of example, the Data Segment Uploader module 117 can monitor for, or be made aware when, new data segments 401 corresponding to a captured media stream are stored at the Segment storage module 116. Data Segment Uploader module 117 is configured to manage queuing of the new data segments in a transmission queue (e.g., queue 403) of the MCC device 100 for transmission over the communication network 152 to an ingestion point of the transcription system 110 (e.g., to an Internet Service Ingestion Endpoint 126 of the transcription system 110, described below). In this regard, FIG. 4 provides an illustrative example of a sequence of WAV format data segments 401(i) to 401(i+N) as stored in a time-ordered first-in-first-out data segment transmission queue 402, with index (i) indicating the first (e.g., oldest) data sequence and index (i+N) indicating the last data sequence (e.g., sequence most recently output by the Live data segment production module 114.

Data Segment Uploader module 117 is also configured to handle the authentication and authorization mechanisms for secure transmission of the data segments to the Backend Ingestion Endpoint 126, and manage the full lifecycle of transmitting the data segments to the Backend Ingestion Endpoint 126, including: (a) monitoring for success or failure of transmission of a data segment through the communication network 152; (b) on successful transmission of a data segment, deleting the data segment from the transmission queue 402 and processing a next data segment in the transmission queue 402; and (b) on transmission error, a persistent recovery process that applies retry logic and error handling to periodically attempt to retransmit the failed data segment and subsequent data segments 402 in an optimized manner. In some examples, the persistent recovery process is configured to leverage available OS level capabilities of the MCC device 100, such as receiving data from the OS components of the MCC device 100 about network connectivity change events. In some example, the persistent recovery process is configured to survive MCC device reboots, connection loss, or other fatal errors. In some examples, the persistent recovery process can survive loss of power at the MCC device (e.g., caused by a drained battery or other battery failure) that may occur during a loss of connectivity).

In some examples embodiments, the Data Segment Uploader module 117 can include the following sub-modules to provide the functionality described in the previous paragraph.

Storage Watcher module 118—module configured to monitor for occurrence of a predetermined change on the persistent storage (e.g., memory 210) used by the segment storage module 116 (e.g., when a new data segment is stored). This module can be notified of such an occurrence by Operating System mechanisms of the MCC capture device 100 when the predetermined change occurs, or can be triggered by other predetermined events to check for occurrence of the predetermined change. For example, the Storage Watcher module 118 could be configured by a periodic timer event or a manual input to periodically do an update scan of a predefined file folder location of the persistent storage to determine if any new data segments 401 have been added since a previous scan. The storage watcher module 118 is configured to order the new data segments into transmission queue 402. In example embodiments, the transmission queue 402 is maintained in persistent storage (e.g., as part of segment storage module 116 in memory 210) of the MCC device 100 to enable the transmission queue 402 to be available or recovered after a failure of the MCC device 100.

Segment Uploader in Sequence module 120—module configured to cause the data segments 401 from the transmission queue 402 to be sequentially transmitted through the communication network 152 by a wireless transmission sub-system of the MCC device 100. Segment Uploader in sequence module 120 can be notified or instructed by storage watcher module 118 when a data segment 401 (e.g., data segment 401(i)) is available for transmission from segment storage 116.

Transmission Validation module 122—module that can determine if one or more predefined error conditions exit in respect of communication network 152. By way of example, the predefined error conditions can include, among other things, one or more of: lack of a network connection to communication network 152; lack of an Internet network connection within the communication network 152; failure of transmission of transmitted data segment to be received by the internet service ingestion endpoint. The Transmission Validation module 122 can indicate when an error condition is detected, as in at least some examples also provide an identification of one or more data segments 401 that are affected by the error condition.

Reschedule uploader task recovery module 124—module that is notified by the Transmission Validation module 122 when an error condition is detected, as well as identification of one or more data segments that are affected by the error condition. The Reschedule uploader task recovery module 124 is configured to communicate with one or both of storage watcher module 118 and Data Segment Uploader module 120 to reschedule transmission of the one or more data segments that are affected by the error condition. In example embodiments, the rescheduling process is persisted and survives MCC device reboots or loss of connection. In some examples, data segment uploader 117 is capable of a retrial within a defined duration (e.g., 10 seconds or such other predefined time) when there is a valid Internet connection. In some examples, data segment uploader 117 is capable of a user initiated retrial when a predefined user input is detected at the MCC device 100 after a connection failure.

In some examples, storage watcher module 118 will automatically delete data segments from the transmission queue if it is not notified of an error condition in respect of the data segments within a defined time period. In some examples, the storage watcher module 118 can receive positive transmission confirmations generated by Transmission Validation module 122 that can be used to trigger deletion of data segments from the transmission queue.

FIG. 5 is a block diagram illustrating a sequence of operations that can be performed by Transmission validation module 122 according to an example implementation. Upon receiving an indication that Data Segment Uploader module 120 has a data segment (e.g. data segment 401(i)) ready for upload, a network connection validation operation 502 is performed to ensure that the MCC device 100 currently has an active connection to communication network 152. In the event that no active network connection exists (e.g., MCC device 100 is currently without network coverage), then the Reschedule uploader task recovery module 124 is notified of the error, thereby ensuring that the data segment 401(i) is maintained in its position as the current-data-segment-to-transmit in the transmission queue 402. However, if an active connection network connection exists, then a security handshake operation 503 is performed via communication network 152 between the MCC device 100 and transcription system 110, following which a transmit data segment operation 504 triggers the Data Segment Uploader module 120 to cause the data segment 401(i) to be transmitted via communication network 152 for the transcription system 110. In some examples, the data segment 401(i) is transmitted to a predefined network address or URL that is preassigned to the transcription system 110. In some examples, the security handshake operation 503 may be omitted from the operations performed by Transmission validation module 122. In some examples, the handshaking could be handled by another module of the system 90 that manages security authorization and authentication.

As indicated by decision operation 506, the internet validation module 122 monitors for confirmation of a successful receipt of the transmitted data segment 401(i) by the transcription system 110. In the event that there is no confirmation of a successful transmission, then the Reschedule uploader task recovery module 124 is notified of the error, thereby ensuring that the data segment 401(i) is maintained in its position as the current-data-segment-to-transmit in the transmission queue 402. However, if the transmission is a success then the storage watcher module 118 deletes the data segment 401(i) from the transmission queue 402 such that the next data segment 401(i+1) becomes the current-data-segment-to-transmit in the transmission queue 402 and the process is repeated. As noted above, in some examples, the transmission validation module 122 actively informs the storage watcher module 118 of a successful transmission, triggering deletion of successfully transmitted data segment 401(i) from the transmission queue. In other examples, storage watcher module 118 is configured to assume a successful transmission if a defined duration passes after the storage watcher module 118 notified the Data Segment Uploader module 120 to transmit the current data segment and no error notification is received by the storage watcher module 118 from the reschedule uploader task recovery module 124.

In some examples, sets of data segments 401 may be processed in a similar manner as a group by data segment uploader, rather that single data segments 401.

In example embodiments, the cloud-based transcription system 110 includes the following modules for processing media content that is received from one or more MCC devices 100 via the communication network 152.

Internet Service Ingestion Endpoint module 126—module that securely receives data segments 401R transmitted by an MCC device 100 in respect of a media content stream. In at least some examples, the Internet Service Ingestion Endpoint module 126 and the data segment uploader 117 of the MCC device 100 are configured to use a communication protocol that enables Internet Service Ingestion Endpoint module 126 to provide a confirmation to the data segment uploader 117 that represents a strong guarantee of having successfully received a data segment. Internet Service Ingestion Endpoint module 126 is configured to reconstitute received data segments into a continuous media stream of recovered data segments 401R that can be stored in a persistent file storage 128 of the transcription system 110. In some examples, the recovered data segments 401R are stored as WAV format audio data.

Media Processor module 130 (Also referred to as a Data Segment Injector)—module that receives recovered data segments 401R as input and outputs processed and sanitized data segments for the next steps of the process. This process can, for example, fix irregularities in the data segments and, in some examples, join them smaller data segments into larger data segments. The Media Processor module 130 feeds the output data segments to two parallel processing streams 131 and 135 in order to provide time-aligned text data (e.g., transcript 134) and media content to a downstream online collaborative editor module 140 (described below). In some examples, the Media Processor module 130 can include different processing operations for the recovered data segments 401R. For example, a first set of processing operations can be applied to output audio data that is in a format optimized for automated transcription (e.g., optimized for processing stream 131) and a second set of processing operations can be applied to the recovered data segments 401R to output audio data that is in a format optimized for audio playback (e.g., optimized for processing stream 135).

Automated Speech Recognition (ASR) module 132—module configured to receive an audio component of the data segments provided by the Media Processor module 130 and generate a corresponding text transcript segment for each data segment. The text transcript segments are appended together to provide a time-stamped transcript for the media content that is represented by the sequence of data segments. The time-stamp metadata included with the transcript 134 provides a time-alignment between the text words in the transcript 134 and the media content that is represented in the data segments. Automated Speech Recognition (ASR) module 132 can, for example, be implemented using an (artificial intelligence) AI-based software program that can transform recorded speech data into text. The time stamped transcript 134 can be provided in real-time or close to real-time to online collaborative editor 140.

Live playlist module 136—module configured to append the data segments from the Data Segment Injection module 130 to a playlist that defines a representation of the original continuous media data stream of audio data (and when included, video data) that was captured by the MCC device 100. For example, the live playlist module 136 can apply a protocol to generate a continuous stream of media content from the data segments. This content can, for example, be stored as one or more media content files in a persistent file storage 138 that is accessible to online collaborated editor module 140.

Online Collaborative Editor 140—modules that allows multiple users using respective client devices 150 to view and edit the same piece of content collaboratively. The content includes the media content files with their time-aligned transcripts.

The combined operation of the MCC device 100 and the transcription system 110 can enable real-time or close to real-time (subject to transmission and processing lags) viewing of media content, together with time-aligned transcription text at the client devices 150 as the media content is being captured by the MCC device 100. Further, the data segment uploader 117 and internet service ingestion system 90 collectively enable connectively issues in communication network 152 to be recognized and addressed to ensure that data segments are ultimately provided to the transcription system 110 in a timely manner.

An example of the operation of the system 90 is as follows:
1. A user initiates a recording of media content data using MCC device 100, for example, an audio or video recording.
2. Audio/video produce module 112 of the MCC device 100 captures the media content and the live data segment production module 114 saves the media content as a series of data segments to local device segment storage 116 (in an illustrative example, data segments are 1 second in length). The data segments are stored in sequential format (either by tagging, file naming convention, or another means).
3. The data segment uploader 117 checks for an active network connection (e.g., a connection to the Internet).
4. If an active network connection exists, the data segment uploader 117 will attempt to send the data segments in sequence to an internet service designed to receive that data and process it (e.g., transcription system 110)
5. If an active network connection does not exist, the data segment uploader 117 will keep attempting to check for that connection, while keeping the recorded data segments intact in the local device storage 116.
6. The internet service ingestion module 126 of the transcription system 110 receives the data segments over an encrypted, authenticated and authorized transport channel.
7. The data segments are then sent by media processor module 130 to both automated speech recognition module 132 for a transcription of the audio to be produced, and to a live playlist module 136, which will allow near real time playback of the reconstituted data.
8. The transcription and the media are displayed using online collaborative editor module 140 available for multiple collaborators using respective client devices 150 to independently view, edit, scrub back and forth to review any point of the recording and transcript.

The system 90 provides a means of creating a live data stream (for example media recording) to a network-based service with inherent accuracy and resilience from an mobile device even in poor connectivity conditions, combined with the ability for other network connected devices to display that data stream, navigate through it using a software editor, and edit the data received to date in near real time.

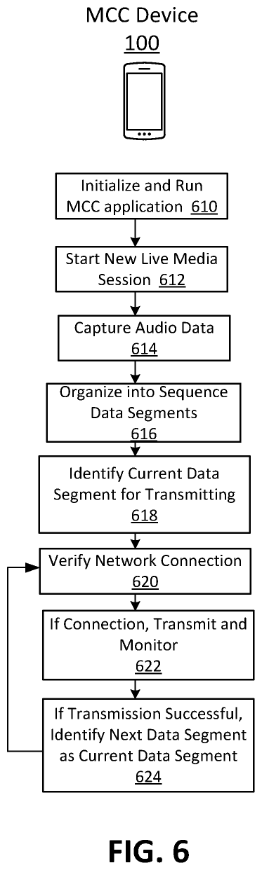

An example of operation of the MCC device 100 will now be summarized with reference to the flow diagram of FIG. 6. As indicated at blocks 610 and 612, one or more predefined trigger events (e.g., detecting a predefined user input) causes the MCC application 162 to initialize and run on the MCC device 100 and start a new live media session. In some examples, MCC device 100 exchanges messages with a remote server (e.g., the transcription system 110) to notify the transcription system 110 of the new live media session.

As indicated at block 614, the MCC device 100 captures a stream of audio data via its microphone. The stream of audio data is processed into a time-ordered sequence of corresponding digital data segments as the stream of audio data is captured (block 616).

As indicated at block 618, a digital data segment from the sequence is identified as a current data segment for transmitting to the transcription system 110 through a communication network 152.

As indicated at block 620, the MCC device verifies whether a valid network connection exists between the first electronic device and the communication network. The verifying is repeated when the verifying fails to indicate that the valid network connection exists.

As indicated at block 622, when the verifying indicates that the valid network connection exists: (i) the current data segment is transmitted over the communication network for the remote server; and (ii) monitoring for confirmation that the current data segment has been successfully transmitted to the transcription system 110. If the monitoring fails to confirm that the current data segment has been successfully transmitted, the operations of blocks 620 and 622 are repeated.

As indicated at block 624, when the monitoring confirms that the current data segment has been successfully transmitted, the MCC device identifies a next digital data segment from the sequence as the current data segment and repeats the operations of blocks 620, 622, and 624. These operations can be performed repeatedly until all digital data segments are provided to the transcription system 110 or a defined termination condition occurs.

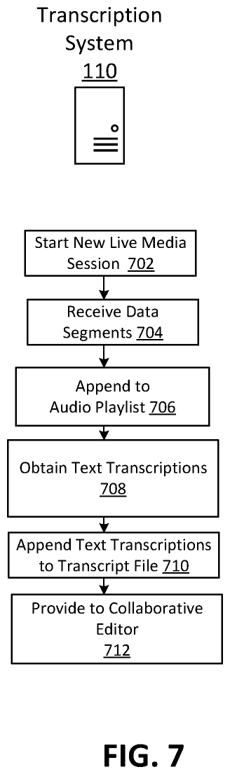

FIG. 7 shows operations performed at the transcription system 110 according to example embodiments. As indicated at block 702, the transcription system 110 can start a new live media session in response to messaging received from the MCC device 100. The transcription system 110 then receives the transmitted sequence of digital data segments (block 704). The digital data segments are appended to an audio playlist as they are received and the audio playlist is stored (block 706). Automated text transcriptions are obtained for the digital data segments as they are received (block 708). The text transcription for each digital data segment includes a text representation of spoken words represented in the digital data segment together with time stamp data that aligns the text representations with locations of the spoken words in the audio playlist.

As indicated at block 710, the text transcriptions are appended to a transcript file in real-time as they are obtained.

As indicated at block 712, the audio playlist and the transcript file can be provided in to a collaborative editor that enables multiple user devices to display the text transcriptions in time alignment with audio playback of the audio playlist.

In some examples, the MCC device 100 arranges the sequence of corresponding digital data segments into a transmission queue, wherein the digital data segment that is identified as a current data segment for transmitting is the oldest data segment in the transmission queue. When the verifying indicates that the valid network connection exists and the monitoring confirms that the current data segment has been successfully received, the digital data segment that was identified as the current data segment is deleted from the transmission queue.

In some examples, a valid network connection is deemed to exist when the verifying does not indicate otherwise within a first defined timeout duration, and the current data segment is deemed to have been successfully transmitted when the confirming does not indicate otherwise within a second defined timeout duration.

Although the present disclosure describes methods and processes with steps in a certain order, one or more steps of the methods and processes may be omitted or altered as appropriate. One or more steps may take place in an order other than that in which they are described, as appropriate.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The features and aspects presented in this disclosure may be embodied in many different forms and should not be construed as limited to the embodiments set forth herein. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all published documents identified in this disclosure are incorporated herein by reference.

1. A method of capturing a live audio stream at a first electronic device for transmission over a communication network that includes the Internet for supporting real-time transcription at a remote server, comprising,
at the first electronic device:
capturing a stream of audio data using a microphone;
processing the stream of audio data into a time-ordered sequence of corresponding digital data segments as the stream of audio data is captured,
arranging the time-ordered sequence of corresponding digital data segments sequentially into a transmission queue stored in a persistent memory of the first electronic device;
providing the sequence of digital data segments over the communication network for the remote server for real-time transcription, the providing comprising:
(a) identifying a digital data segment from the sequence as a current data segment for transmitting, wherein the digital data segment that is identified as a current data segment for transmitting is the oldest data segment in the transmission queue;
(b) verifying whether a valid network connection exists between the first electronic device and the communication network, and repeating the verifying when the verifying fails to indicate that the valid network connection exists;
(c) when the verifying indicates that the valid network connection exists: (i) transmitting the current data segment over the communication network for the remote server; and (ii) monitoring for confirmation that the current data segment has been successfully transmitted to the remote server;
(d) when the monitoring fails to confirm that the current data segment has been successfully transmitted, repeating (b) and (c); and
(e) when the monitoring confirms that the current data segment has been successfully transmitted, identifying a next digital data segment from the sequence as the current data segment and repeating (b), (c) and (d).

2. The method of claim 1 wherein (b), (c), (d) and (e) are preformed repeatedly until all digital data segments in the sequence are provided to the remote server or a defined termination condition occurs.

3. The method of claim 2 wherein the defined termination condition comprises the verifying failing, for a predefined duration, to indicate that the valid network connection exists.

4. The method of claim 1 comprising:
at the remote server:
receiving the sequence of digital data segments;
appending the digital data segments to an audio playlist as they are received and storing the audio playlist;
obtaining automated text transcriptions for the digital data segments as they are received, the text transcription for each digital data segment including a text representation of spoken words represented in the digital data segment together with time stamp data that aligns the text representations with locations of the spoken words in the audio playlist; and
appending the text transcriptions to a transcript file in real-time as they are obtained.

5. The method of claim 4 comprising:
providing the audio playlist and the transcript file in real-time to a collaborative editor that enables multiple user devices to display the text transcriptions in time alignment with audio playback of the audio playlist.

6. The method of claim 5 comprising:
accessing the collaborative editor over the communication network by one or more of the multiple user devices.

7. The method of claim 1, wherein:
at the first electronic device, processing the stream of audio data into a time-ordered sequence of corresponding digital data segments comprises generating and saving the digital data segments in the persistent memory in a Waveform Audio FILE Format WAV.

8. The method of claim 7 wherein at the first electronic device, the stream of audio data is a pulse code modulated (PCM) byte array stream and each of the digital data segments is saved as a respective WAV file.

9. The method of claim 1 comprising:
when, during the providing the sequence of digital data segments in real-time to the remote server, the verifying indicates that the valid network connection exists and the monitoring confirms that the current data segment has been successfully received, deleting the digital data segment that identified as the current data segment from the transmission queue.

10. The method of claim 1 wherein the verifying is deemed to indicate that the valid network connection exists when the verifying does not indicate otherwise within a first defined timeout duration.

11. The method of claim 10 wherein the confirming is deemed to confirm that the current data segment has been successfully transmitted when the confirming does not indicate otherwise within a second defined timeout duration.

12. The method of claim 1 wherein the first electronic device is a common-off-the-shelf (COTS) device provisioned with an application to enable the first electronic device to perform the receiving the stream of audio data, the processing of the stream of audio data into the time-ordered sequence of corresponding digital data segments, the providing the sequence of digital data segments over the communication network.

13. The method of claim 1 wherein the live audio stream is part of a media stream that also includes a live video stream.

14. (canceled)

15. (canceled)

16. A processor enabled electronic device comprising:
a media stream capture module configured to capture real-time audio data obtained through a microphone and output a corresponding stream of digital audio data;
a live data segment production module configured to divide the digital audio data into a time-ordered sequence of data segments;
a segment storage module configured to store the time-ordered sequence of data segments in a transmission queue in a persistent memory of the electronic device;
a data segment uploader module configured to upload the sequence of data segments in sequential order through a communications network to a remote server that is configured to generate speech-to-text transcriptions, by performing the following operations for each of a plurality of the data segments:
verifying whether the electronic device has a valid network connection with the communication network;
when the verifying indicates that a valid network connection does not exist, repeating the verifying until a valid network connection exists or a first defined terminal condition is reached;
when the verifying indicates that the valid network connection exists: (i) transmitting the data segment over the communication network for the remote server; and (ii) monitoring for confirmation that the data segment has been successfully transmitted to the remote server; and
when the monitoring fails to confirm that the data segment has been successfully transmitted, repeating the transmitting and monitoring until the monitoring confirms the data segment has been successfully transmitted or a second defined terminal condition is reached.

17. The electronic device of claim 16 wherein the first defined terminal condition and the second defined terminal condition are each one or more of: (1) a defined number of attempts; and (2) a defined duration of time.

18. The electronic device of claim 16 in combination with the remote server, the remote server being configured to:
receive the sequence of digital data segments through the communication network;
assemble the digital data segments into an audio playlist as they are received;
obtain automated text transcriptions for the digital data segments as they are received, the text transcription for each digital data segment including a text representation of spoken words represented in the digital data segment together with time stamp data that aligns the text representations with locations of the spoken words in the audio playlist; and
appending the text transcriptions to a transcript file as they are obtained.

19. The combination of electronic device and the remote server of claim 18, wherein the remote server is configured to provide the audio playlist and the transcript file in real-time to a collaborative editor that enables multiple user devices to display the text transcriptions in time alignment with audio playback of the audio playlist.

20. The electronic device of claim 16 wherein the communications network comprises the Internet, and the stream of digital audio data output by the media stream capture module is a pulse code modulated (PCM) stream and each digital data segment is formatted as a discrete Waveform Audio File Format (WAV) file that has a WAV file header and one PCM data segment that encodes a defined duration of digital audio data.

21. The method of claim 1 further comprising:
at the first electronic device:
prior to capturing the stream of audio data:
causing an application to initialize, and
causing the application to commence a live media session, wherein causing the live media session to commence causes the first electronic device to exchange messages with the remote server via the communication network to cause the remote server to start a corresponding live media session and causes the first electronic device to start capturing the stream of audio data;
while providing the sequence of digital data segments over the communication network, tracking and storing status data in the persistent memory that indicates a current state of the live media session, the status data indicating if the live media session is currently in an active state, a completed state, or an interrupted state, wherein an interrupted state corresponds to a loss of network connectivity during the live media capture session;
wherein causing the application to initialize causes the first electronic device, prior to causing the application to commence the live media session, to check the persistent memory for stored status data indicating a status for a last live media session, and, in response to detecting the status for the last live media session indicates an interrupted state, enabling a providing of a sequence of digital data segments in a transmission queue corresponding to the last live media session and stored in the persistent memory to recommence over the communication network.
